(19) United States
(12) Patent Application Publication
(10) Pub. No.: US 2013/0345027 A1
(43) Pub. Date: Dec. 26, 2013

(54) WHEELBARROW WALKER DEVICE

(71) Applicant: Lauren Haggerty, Rehoboth Beach, DE (US)

(72) Inventor: Lauren Haggerty, Rehoboth Beach, DE (US)

(21) Appl. No.: 13/532,697

(22) Filed: Jun. 25, 2012

(51) Int. Cl. A63B 22/00; B62M 1/14

(52) U.S. Cl. 482/51; 280/242.1

(57) ABSTRACT

A wheelbarrow walker device designed to accommodate a human user lying prone, comprising a seat for supporting a user lying face-down on their abdomen or thighs, a plurality of substantially vertical supports for maintaining the seat at an elevation above a floor or other hard surface, a plurality of rolling wheels coupled to the distal end of the vertical supports to enable the device to be rolled along the floor or other hard surface, wherein a human user receiving therapy propels the device and the user using the user's hands in a conventional wheelbarrow walker therapy, and the device supports the weight of the user's midsection, thereby reducing strain on the user or on an assisting therapist.

### BACKGROUND OF THE INVENTION

1. Field of the Invention

The present invention relates to the field of physical therapy, and more specifically to physical therapy devices for strengthening of the muscles and training in coordination and locomotion.

2. Discussion of the State of the Art

In the field of physical therapy, there is a common need to strengthen the core muscles of a child who may be suffering from any of a number of conditions affecting muscular growth or development. It is a common practice for a therapist to grasp the child's hip or upper thighs and elevate them so that the child's body is horizontal or slightly elevated above the horizontal plane. The child rests their palms on the floor, and is instructed to keep their midsection as straight as possible while walking about on their hands as the therapist supports their feet. It will be appreciated that this can raise safety concerns—such as if the child were to experience muscle failure and collapse, or if the therapist were to lose their grip on the child. It will be further appreciated that this can have serious impact on the therapist's physical well-being, exerting strain on the lower back while they remain hunched over supporting the child's weight.

### SUMMARY OF THE INVENTION

In order to solve the problems described above with both existing physical therapy practices and improvised solutions using a rolling chair, the inventor conceived of the present invention.

In a preferred embodiment of the invention, a device for supporting a human user (hereinafter referred to as a “wheelbarrow walker device”) comprising a seat designed to comfortably accommodate a physical therapy patient (hereinafter referred to as a “user”) while lying in a prone position on their abdomen and a plurality of wheels or casters, is disclosed. The overall design of the wheelbarrow walker device is such that a user may lie prone on their abdomen, pelvic region, or thighs while facing the floor, and the wheelbarrow walker device will support their weight to such an extent that they may then use their arms and upper body for locomotion about an area. This design will permit therapists to assist their patients with greater ease, and offers greater comfort and security for the patient—giving a boost to confidence and performance, thus increasing the benefit of the physical therapy itself. The seat of such a wheelbarrow walker device may be shaped with contours to comfortably accommodate a user, and it will be appreciated by one having ordinary skill in the art that the contours may be of varied design within the scope of the invention, and it will be further appreciated that a seat may be designed with a moldable surface of a foam or similar material, to facilitate comfortable accommodation of a user. Affixed to the seat are a plurality of vertical supports with wheels further affixed, designed in such a way as to facilitate free rolling movement on a carpeted or smooth floor surface. It will be appreciated by one having ordinary skill in the art that the number and physical arrangement of supports and wheels may vary while still facilitating necessary movement according to the invention, and further that such wheels may be designed with full 360-degree or limited rotation or with a plurality of locking mechanisms such as for preventing translational or rotational movement of one or more wheels, such as a wheel-mounted lever locking mechanism or a pedal mounted either near the seat or near to the wheel base for activation with a foot. It will be appreciated by one having ordinary skill in the art that such locking mechanisms are exemplary and many variations are possible according to the invention. Each wheel may have a smooth, curved plate affixed as a “shield” to prevent a user's hands from coming into contact during use, while still allowing for the necessary rotational movement of the wheels contained within. Such a shield may be affixed to all wheel, or only to the front wheels nearest to a user's hands during use, and it will be appreciated that such configurations are exemplary and many more arrangements are possible according to the invention. The supports or seat of such a wheelbarrow walker device may be designed in such a way as to facilitate adjustment of a plurality of seat features such as height or angle, and it will be appreciated by one having ordinary skill in the art that such adjustment may be accomplished by one of many methods, such as individual adjustment of the height of each of multiple supports, or by adjusting a single central support which serves to connect a wheelbase to the seat.

In another preferred embodiment, a device comprising a plurality of rolling wheels and a seat designed to comfortably accommodate a human user while lying prone on their abdomen and having a removable seat cover, is disclosed. According to this embodiment, a seat has a removable cover affixed, which may be of varied construction to facilitate use in a wide variety of scenarios. It will be appreciated by one having ordinary skill in the art that the material composition of the seat cover may vary according to the invention, including such configurations as a washable cover designed for comfort or a single-use cover for sanitary use in a clinical environment. It will be further appreciated that such a removable cover may be attached via a variety of means, including hook-and-loop fastenable means, elastic portions wrapped about the underside of a seat, string-type ties, or button-style snaps. Such fastenable means are provided as examples, and are not limitations of the invention, and many such fastenable means are possible within the scope of the invention.

In a further embodiment, a device comprising a plurality of rolling wheels and a seat designed to comfortably accommodate a human user while lying prone on their abdomen and having a removable structural insert, is disclosed. According to this embodiment, a structural insert may be affixed upon or about the top of a seat portion of a wheelbarrow walker device, via a variety of means such as a plurality of posts which mate with sockets in the upper surface of a seat. It will be appreciated by one having ordinary skill in the art that many varied means are possible according to the invention. Such a structural insert may be of varied material construction and physical shape, to suit a variety of purposes such as an angled, rigid or semi-rigid inclined surface to adjust the angle of a user, or a padded and curved “saddle” shape to increase user comfort. It will be appreciated that such designs are exemplary and many others are possible according to the invention. It will be further appreciated that according to this embodiment a removable seat cover may be affixed about a seat while a structural insert is affixed, to further extend the functionality of the wheelbarrow walker device.

### BRIEF DESCRIPTION OF THE DRAWING FIGURES

FIG. 1 is a drawing of a preferred embodiment of the invention, illustrating the general design and adjustment.

FIG. 2 is a further drawing of a preferred embodiment of the invention, illustrating alternate arrangements of wheels.

FIG. 3 is an illustration of an embodiment of the invention, illustrating a removable seat cover and a variety of fastenable means.

FIG. 4 is an illustration of an embodiment of the invention, illustrating a removable structural insert.

FIG. 5 is an illustration of a method of using the invention, with reference to the prior embodiments.

### DETAILED DESCRIPTION

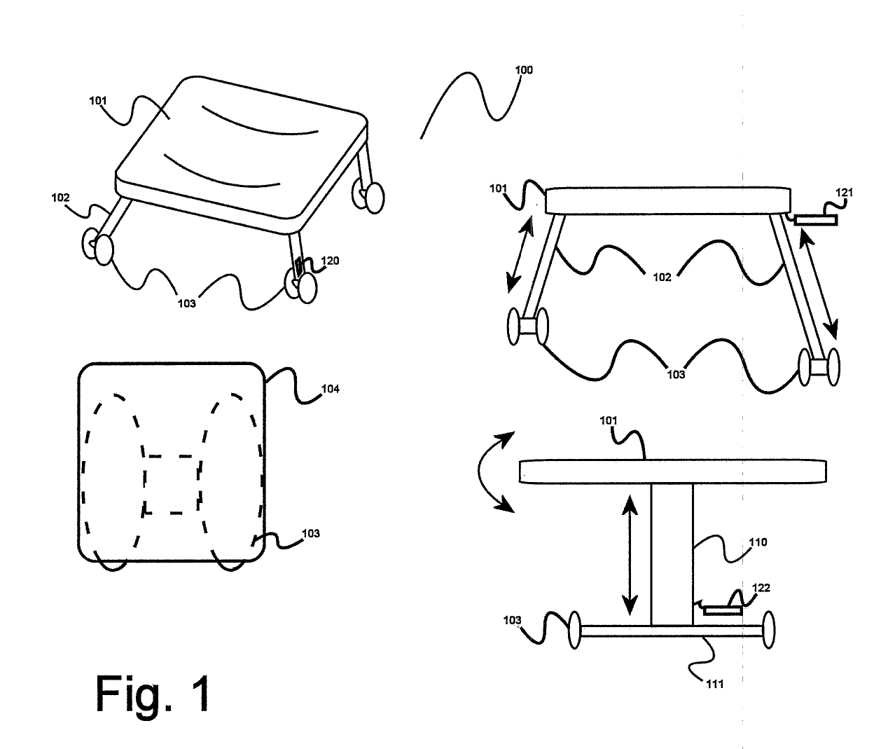

FIG. 1 is an illustration of a preferred embodiment of a wheelbarrow walker device 100, comprising a seat 101 with a plurality of vertical supports 102 affixed, each of which has a plurality of wheels 103 further affixed. As illustrated, each support 102 may be adjustable for height, with such independent adjustments facilitating a variance in both height and positional angle of a seat 101. Such adjustment may be utilized to facilitate use by a variety of users, such as young children or larger adult patients as needed, as well as facilitating use by users of a variety of physical conditions or builds. One or more wheels 103 may have a mechanical shield 104 affixed, to prevent a user's hands from coming into contact with wheels 103 while allowing the necessary rotational movement of wheels 103. As further illustrated, a seat 101 may be affixed to a central support 110 to which a wheelbase 111 is affixed, with wheels 103 further affixed. As illustrated, one or more supports 102 may incorporate a lever-based locking mechanism 120 designed to prevent rotational or translational movement of a wheel 103, and that seat 101 may be designed having a paddle 121 which remotely locks such movement of one or more wheels 103, and further that a central support 110 may be similarly supplied with a paddle 122 to lock one or more wheels 103. It will be appreciated by one having ordinary skill in the art that the illustrated arrangement is exemplary, and alternate configurations are possible within the scope of the invention, such as affixing a plurality of horizontal supports to a central pillar 110 in place of a singular wheelbase 111.

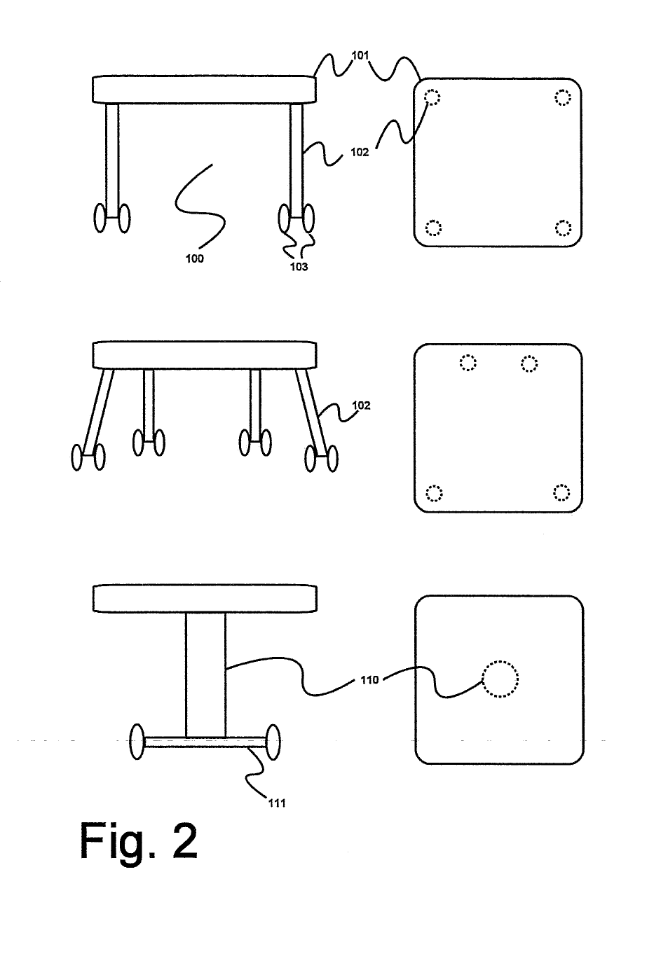

FIG. 2 is an illustration of multiple embodiments of a wheelbarrow walker device 100, illustrating various arrangements of both supports 102 and wheels 103. As illustrated, supports 102 may be positioned about the edge of a seat 101 and extending downwards at an angle perpendicular to the surface of seat 101, or alternatively such supports 102 may be positioned in asymmetrical arrangements or extending at a downward angle other than perpendicular, such as an outward angle as illustrated to facilitate a wide wheelbase for stability and ease of use. As further illustrated, a central support 110 may be positioned in the center of seat 101 for stability, having a wheelbase 111 affixed with a plurality of wheels 103 positioned with radial symmetry relative to the central support 110, facilitating a stable platform for a user as well as accommodating motion of a user's hands without risk of contact with wheels 103. It will be appreciated that the illustrated arrangements are exemplary in nature and meant only to further illustrate possible designs according to the invention, and should not be construed as limiting in nature as other arrangements are possible within the scope of the invention.

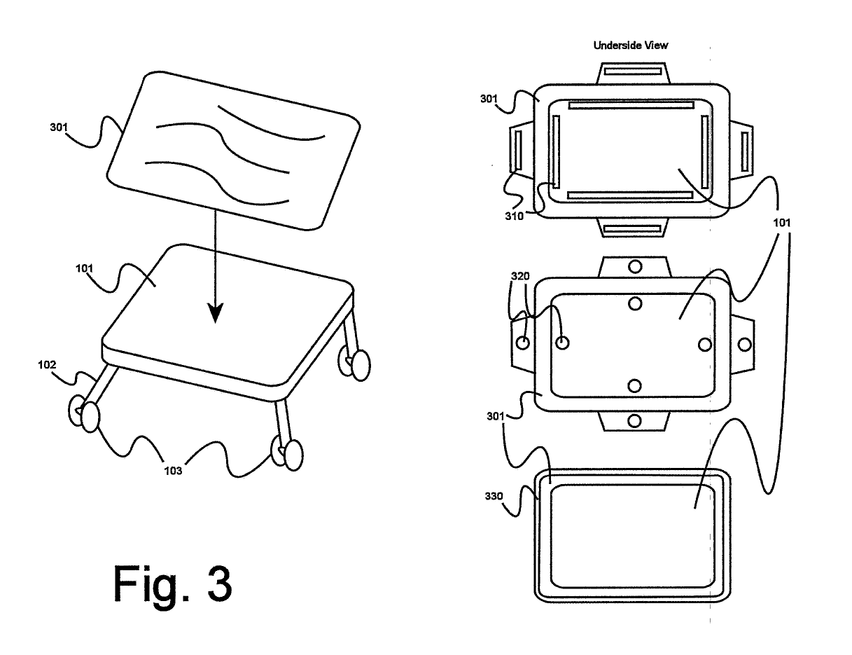

FIG. 3 is an illustration of an embodiment of the invention, illustrating the use of a removable seat cover 301 affixed to a seat 101. As illustrated, a removable seat cover 301 may be affixed about a seat 101 via several different fastenable means, including but not limited to mating hook-and-loop fastener 310 arranged in patches or strips, button-type snaps 320, or a wraparound elastic band 330. Fastenable means illustrated are exemplary, and it will be appreciated by one having ordinary skill in the art that many other means are possible within the scope of the invention. The material construction of removable seat cover 301 may vary according to the invention, such as a disposable cover for hygienic purposes or a thick cover made of a moldable foam or similar material for comfort of a user. Such materials are exemplary, and it will be appreciated that many other variations are possible according to the invention.

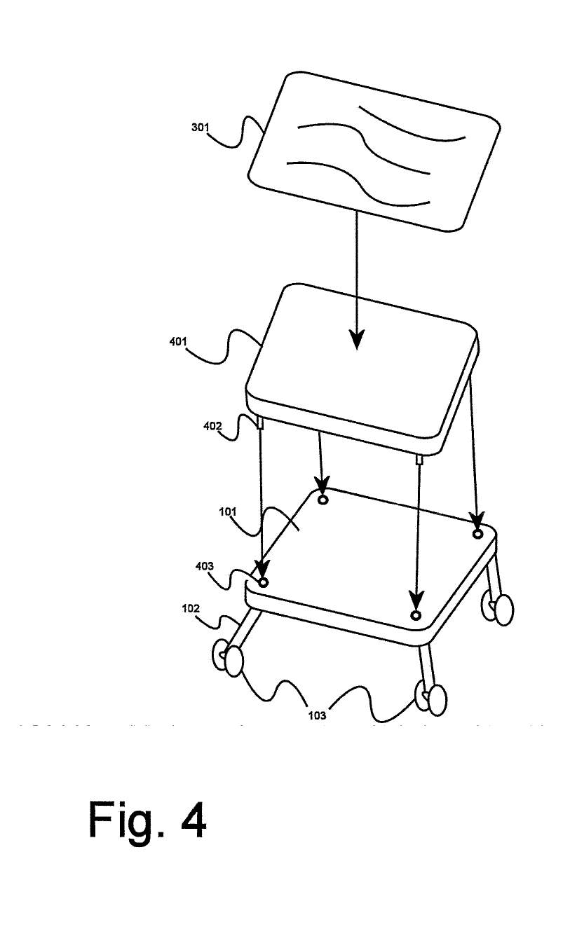

FIG. 4 is an illustration of an embodiment of the invention, illustrating the use of a removable support 401 affixed to a seat 101. As illustrated, removable support 401 may have a plurality of fastener pegs 402 affixed, which align with and insert into complementary sockets 403 in the surface of a seat 101. It will be appreciated by one having ordinary skill in the art that such a method of fixture is exemplary, and additional methods may be used according to the invention. It will be further appreciated that sockets 403 may be molded into the surface of seat 101, or they may be separate and affixed via a variety of means to allow the removal and interchangeability of additional sockets 403, such as to accommodate varying designs of fastener pegs 402. In this way a multitude of removable supports 401 may be affixed to a single seat 101, extending the functionality of a single wheelbarrow apparatus to multiple environments or users.

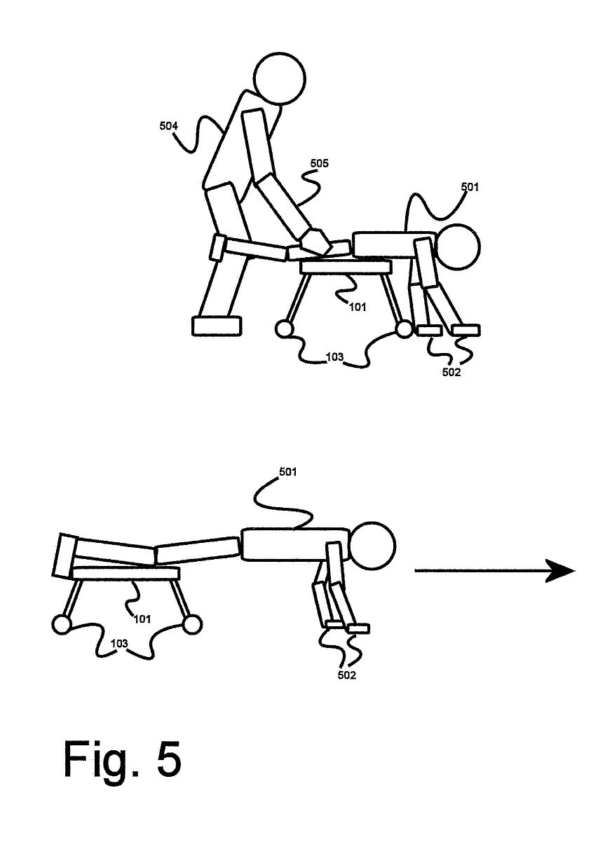

FIG. 5 is an illustration of a method of using the invention, with reference to the previous embodiments. As illustrated, a user 501 may lie down on a seat 101 while facing the floor, with support given by seat 101 as well as user's arms 502. A therapist 503 may stand behind user 501 to provide additional assistance and to “push” with their arms to assist user 501. As further illustrated, a user 501 may proceed alone, using their arms 502 for forward movement. It will be appreciated by one having ordinary skill in the art that such use cases are exemplary, and many other means of utilizing the invention are possible according to the invention.

According to various embodiments of the invention, cover 301 may comprise a surface material or fabrication that affords a relatively high friction surface, in order to assist in a user's remaining in solid contact with seat 101 as the user moves along a floor or hard surface propelled by the user's hands (with or without assistance from a therapist). It should be appreciated by one having ordinary skill in the art that a slick surface of seat 301 may tend to cause a user to slip along seat 101 (or even to fall off of, or become disengaged with, seat 101), which would tend to diminish therapeutic efficacy of the invention (and which may present a safety hazard to users or therapists, as well).

It should also be noted that devices such as those described above (and claimed below) might be used for non-therapeutic purposes as well. For example, device 100 might be used to assist a user in exercising at a gymnasium or fitness center.

All of the embodiments outlined in this disclosure are exemplary in nature and should not be construed as limitations of the invention except as claimed below.

What is claimed is:

1. A wheelbarrow walker device designed to accommodate a human user lying prone, comprising:
a seat for supporting a user lying face-down on their abdomen or thighs;
a plurality of substantially vertical supports for maintaining the seat at an elevation above a floor or other hard surface;
a plurality of rolling wheels coupled to the distal end of the vertical supports to enable the device to be rolled along the floor or other hard surface;
wherein a human user receiving therapy propels the device and the user using the user's hands in a conventional wheelbarrow walker therapy, and the device supports the weight of the user's midsection, thereby reducing strain on the user or on an assisting therapist.

2. The device of claim 1, wherein the supports have mechanical locks to impede movement of the wheels.

3. The device of claim 1, further comprising a removable cover for the seat.

4. The device of claim 3, wherein the removable cover is disposable.

5. The device of claim 3, wherein the removable cover is designed to mold and conform to a user.

6. The device of claim 3, further comprising a removable structural support adapted for easy attachment to and removal from the seat.

7. The device of claim 6, wherein the structural support is designed to position a user at an angle with relation to the floor or ground.

8. The device of claim 6, wherein the structural support is designed of a moldable material for user comfort.

9. The device of claim 6, wherein the removable cover is affixed about the seat and removable structural support.

10. A method of use of a wheelbarrow walker device for training patient locomotion and upper body strength, the method comprising the steps of:
(a) positioning a user on the device in a prone position with either the user's abdomen or the user's thighs resting on a movable device comprising a seat and adjusted to a height and form that is comfortable for the user;
(b) placing the user's hands on a floor or other hard surface in front of the device;
(c) optionally lifting, by a therapist or other person, the user's feet to place the user in a position analogous to the wheelbarrow walk position known in the art, but with the user's midsection supported by the device; and
(d) propelling the user along the floor by having the user walk using the user's hands on the floor or other hard surface.
